(19) United States
(12) Patent Application Publication
(10) Pub. No.: US 2003/0013508 A1
(43) Pub. Date: Jan. 16, 2003

(54) Computer readable recording medium recording a program of a video game, program of a video game, video game processing method, and video game processing apparatus

(75) Inventor: Yasuhiro Sato, Saitama (JP)

Correspondence Address: GREENBLUM & BERNSTEIN, P.L.C., 1941 ROLAND CLARKE PLACE, RESTON, VA, 20191, US

(73) Assignee: SQUARE Co., Ltd., Tokyo (JP)

(21) Appl. No.: 09/973,118

(22) Filed: Oct. 10, 2001

(30) Foreign Application Priority Data
Jul. 13, 2001 (JP) 2001-214401

(51) Int. Cl. A63F 13/00

(52) U.S. Cl. 463/8

(57) ABSTRACT

A speech can be flexibly selected in accordance with the state of a character and the progress state of a game, so that a loss of interest is prevented. In a battle start processing, a present hit point HP is compared with a threshold value T1 and it is judged whether or not (HP>T1) is satisfied. In the case where (HP>T1) is satisfied, a comfortable rush voice is selected, and in the case where (HP>T1) is not satisfied, the HP is compared with a threshold T2 (T1>T2), and it is judged whether or not (HP<T2) is satisfied. In the case where (HP<T2) is satisfied, a hard battle rush voice is selected. In a battle end processing, the present hit point HP is compared with a threshold value T3, and in the case where (HP>T3) and predetermined conditions are satisfied, a comfortable victory voice is selected. In the case where (HP>T3) is not satisfied, HP is compared with a threshold value T4 (T3>T4), and in the case where (HP>T4) and the predetermined conditions are satisfied, an average victory voice is selected. In the other case where the predetermined conditions are satisfied, a hard battle victory voice is selected.

### CROSS REFERENCE TO RELATED APPLICATION

The present disclosure relates to subject matter contained in Japanese patent Application No. 2001-214401, filed on Jul. 13, 2001, the disclosure of which is expressly incorporated herein by reference in its entirety.

### BACKGROUND OF THE INVENTION

1. Field of the Invention

The present invention relates to a computer readable recording medium recording a program of a video game in which characters, including player characters and enemy characters, are displayed on a screen, and a battle between the characters can be controlled, a program of a video game, a video game processing method, and a video game processing apparatus.

2. Description of the Related Art

As one of a plurality of genres of video games using computers, a role playing game (hereinafter referred to as an RPG) is known. In the RPG, a character plays a role on a game instead of a player, and a story is generally developed while the player experiences a pseudo adventure through a character (hereinafter referred to as a player character) operated by the player. In many cases, a character (hereinafter referred to as an enemy character) fighting against the player character is set in each set zone formed in a virtual space. The player character advances to the respective zones, the player character fights against the enemy character who prevents achievement of an object in the story, and the player character beats the enemy character, so that the story is developed.

The player character is typically controlled by manipulating buttons on a key pad, a joy stick, or the like. The player character is moved in response to the operation executed by the key pad and performs a predetermined action. In the progress of the story, many events, such as, for example, a battle scene and a conversation scene are provided. The player carries out a predetermined operation in this event so that the game progresses.

However, in a conventional video game or the like, in the case where a character speaks his lines, previously prepared predetermined speeches are only repeated in a predetermined relation, and the correspondence of the speeches to the progress of the game and the state on the screen is not achieved, which has a problem that there is no reality, which results in the loss of interest in the game. Thus, a video game which can flexibly select speeches in accordance with the state of a character and the progress state of the game is desired.

### SUMMARY OF THE INVENTION

The present invention has been made in view of the above problem, and an object thereof is to provide a computer readable recording medium recording a program of a video game in which speeches can be flexibly selected in accordance with the state of a character and the progress state of the game and the loss of interest can be prevented, a program of a video game, a video game processing method, and a video game processing apparatus.

In order to solve the above problem and to achieve the above object, according to a first aspect of the present invention, a computer readable recording medium records a program of a video game in which characters including player characters and enemy characters are displayed on a screen and a battle between the characters can be controlled, and the program causes a computer to execute a step of comparing a parameter for regulating action power of a character with a predetermined threshold value, and a step of selecting a predetermined speech from previously prepared speeches in accordance with a comparison result obtained at the comparing step.

According to this first aspect, since the predetermined speech is selected and is reproduced in accordance with the state of the character, the recording medium which can prevent the loss of interest can be provided.

In the first aspect, the previously prepared speeches may include speeches which can be repeatedly selected and speeches which can not be again selected when they are once selected. By this, the speeches are diversified, and the recording medium which can further prevent the loss of interest can be provided.

Besides, in the first aspect, the previously prepared speeches correspond to the respective characters, and at the selecting step, the predetermined speeches may be successively selected. By this, a series of speeches between the respective characters can be made into a dialogue, and the recording medium which can further prevent the loss of interest can be provided.

In the first aspect, the previously prepared speeches include speeches which have the same content and different tones, and at the selecting step, a speech of a predetermined content and a predetermined tone may be selected in accordance with a comparison result obtained at the comparing step. By this, not only the content of the speech is selected in accordance with the state of the character, but also the tone of the speech is made a predetermined one, so that the recording medium which can further prevent the loss of interest can be provided.

Besides, in the first aspect, the recording medium may record the program which further causes the computer to execute a step of judging a progress state of the game, and at the selecting step, a predetermined speech is selected among the previously prepared speeches also in accordance with a judgment result obtained at the judging step. By this, since the predetermined speech is selected and reproduced also in accordance with the progress state of the game, the recording medium which can further prevent the loss of interest can be provided.

Besides, in the first aspect, the recording medium may record the program which further causes the computer to execute a step of deciding a character who utters the predetermined speech, and a step of judging whether or not the predetermined speech is made effective on the basis of the character decided at the deciding step and information given to the character and set in accordance with each set zone of a virtual space. By this, the relation between the character who utters the speech and the speech can be made complicated, and the recording medium which can further prevent the loss of interest can be provided.

Besides, in the first aspect, the recording medium may record the program which further causes the computer to execute a step of switching to an image from a predetermined viewpoint among previously prepared images from viewpoints in accordance with a comparison result obtained at the comparing step. By this, the predetermined speech is uttered, and in accordance with that, it is possible to switch to the image from the predetermined viewpoint, so that the realism is further raised, and the recording medium which can further prevent the loss of interest can be provided.

According to a second aspect of the present invention, a program of a video game in which characters, including player characters and enemy characters, are displayed on a screen and a battle between the characters can be controlled, causes a computer to execute a step of comparing a parameter for regulating action power of a character with a predetermined threshold value, and a step of selecting a predetermined speech from previously prepared speeches in accordance with a comparison result obtained at the comparing step.

According to this second aspect, since the predetermined speech is selected and is reproduced in accordance with the state of the character, it becomes possible to prevent the loss of interest.

In the second aspect, the previously prepared speeches may include speeches which can be repeatedly selected and speeches which can not be again selected when they are once selected. By this, the speeches are diversified, and it becomes possible to further prevent the loss of interest.

Besides, in the second aspect, the previously prepared speeches correspond to the respective characters, and at the selecting step, the predetermined speeches may be successively selected. By this, the series of speeches between the respective characters can be made a dialogue, and it becomes possible to further prevent the loss of interest.

Besides, in the second aspect, the previously prepared speeches include speeches which have the same content and different tones, and at the selecting step, a speech of a predetermined content and a predetermined tone may be selected in accordance with a comparison result obtained at the comparing step. By this, not only the content of the speech is selected in accordance with the state of the character, but also the tone of the speech is made a predetermined one, so that it becomes possible to further prevent the loss of interest.

Besides, in the second aspect, the program may further cause the computer to execute a step of judging a progress state of the game, and at the selecting step, a predetermined speech is selected among the previously prepared speeches in accordance with a judgment result obtained at the judging step. By this, since the predetermined speech is selected and reproduced in accordance with the progress state of the game, it becomes possible to further prevent the loss of interest.

Besides, in the second aspect, the program may further cause the computer to execute a step of deciding a character who utters the predetermined speech, and a step of judging whether or not the predetermined speech is made effective on the basis of the character decided at the deciding step and information given to the character and set in accordance with each set zone of a virtual space. By this, the relation between the character who utters the speech and the speech can be made complicated, and it becomes possible to further prevent the loss of interest.

Besides, in the second aspect, the program may further cause the computer to execute a step of switching to an image from a predetermined viewpoint among previously prepared images from viewpoints in accordance with a comparison result obtained at the comparing step. By this, the predetermined speech is uttered and in accordance with that, it is possible to switch to the image from the predetermined viewpoint, so that the realism is further raised, and it becomes possible to prevent the loss of interest.

According to a third aspect of the present invention, a video game processing method in which characters including player characters and enemy characters are displayed on a screen and a battle between the characters can be controlled, comprises a step of comparing a parameter for regulating action power of a character with a predetermined threshold value, and a step of selecting a predetermined speech from previously prepared speeches in accordance with a comparison result obtained at the comparing step.

According to this third aspect, since the predetermined speech is selected and is reproduced in accordance with the state of the character, it becomes possible to prevent the loss of interest.

In the third aspect, the previously prepared speeches may include speeches which can be repeatedly selected and speeches which can not be again selected when they are once selected. By this, the speeches are diversified, and it becomes possible to further prevent the loss of interest.

Besides, in the third aspect, the previously prepared speeches correspond to the respective characters, and at the selecting step, the predetermined speeches may be successively selected. By this, the series of speeches between the respective characters can be made a dialogue, and it becomes possible to further prevent the loss of interest.

Besides, in the third aspect, the previously prepared speeches include speeches which have the same content and different tones, and at the selecting step, a speech of a predetermined content and a predetermined tone may be selected in accordance with a comparison result obtained at the comparing step. By this, not only the content of the speech is selected in accordance with the state of the character, but also the tone of the speech is made a predetermined one, so that it becomes possible to further prevent the loss of interest.

Besides, in the third aspect, the video game processing method may further comprise a step of judging a progress state of the game, and at the selecting step, a predetermined speech is selected among the previously prepared speeches also in accordance with a judgment result obtained at the judging step. By this, since the predetermined speech is selected and reproduced in accordance with the progress state of the game, it becomes possible to further prevent the loss of interest.

Besides, in the third aspect, the video game processing method may further comprise a step of deciding a character who utters the predetermined speech, and a step of judging whether or not the predetermined speech is made effective on the basis of the character decided at the deciding step and information given to the character and set in accordance with each set zone of a virtual space. By this, the relation between the character who utters the speech and the speech can be made complicated, and it becomes possible to further prevent the loss of interest.

Besides, in the third aspect, the video game processing method may further comprise a step of switching to an image from a predetermined viewpoint among previously prepared images from viewpoints in accordance with a comparison result obtained at the comparing step. By this, the predetermined speech is uttered and in accordance with that, it is possible to switch to the image from the predetermined viewpoint, so that the realism is further raised, and it becomes possible to prevent the loss of interest.

According to a fourth aspect of the present invention, a video game processing apparatus comprises a storage device for storing a program of a video game which causes characters, including player characters and enemy characters, to be displayed on a screen and can control a battle between the characters, a computer for executing the program read out of the storage means, and a display device for screen display, which is provided as output means of the computer, the computer executing the program so that it compares a parameter for regulating action power of a character with a predetermined threshold value, and selects a predetermined speech from previously prepared speeches in accordance with a comparison result obtained by the comparison.

According to the fourth aspect, since the predetermined speech is selected and reproduced in accordance with the state of the character, it becomes possible to prevent the loss of interest.

### BRIEF DESCRIPTION OF THE DRAWINGS

FIG. 1 is a block diagram showing the whole structure of an embodiment of the present invention;

FIG. 2 is a flowchart used for explanation of the whole operation of the embodiment;

FIG. 3 is a flowchart used for explanation of a battle operation reception and battle processing execution in the embodiment of the present invention;

FIG. 4 is a flowchart used for explanation of a battle start processing in the embodiment of the present invention;

FIG. 5 is a flowchart used for explanation of a battle end processing in the embodiment of the present invention;

FIG. 6A is an explanatory view showing an example of a display screen in the embodiment of the present invention;

FIG. 6B is an explanatory view showing an example of a display screen in the embodiment of the present invention; and

FIG. 6C is an explanatory view showing an example of a display screen in the embodiment of the present invention.

### DETAILED DESCRIPTION OF THE PREFERRED EMBODIMENTS

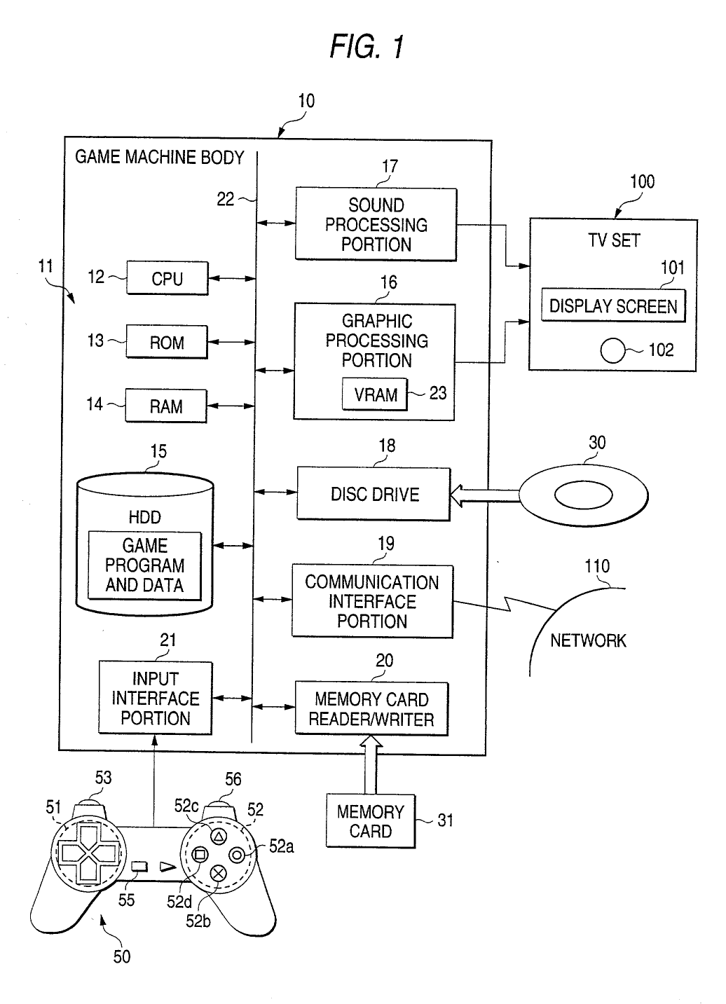

Hereinafter, an embodiment of the present invention will be described with reference to the accompanying drawings. FIG. 1 is a block diagram showing the whole structure of the embodiment of the present invention.

First, a video game machine of the embodiment of the present invention will be described. A game machine 10 comprises a game machine body 11 and a key pad 50 that is connected to an input side of the game machine body 11. A television set 100, including a CRT (Cathode Ray Tube), a speaker, and the like, is connected to an output side of the game machine body 11.

The game machine body 11 includes a CPU (Central Processing Unit) 12, a ROM (Read Only Memory) 13, a RAM (Random Access Memory) 14, a hard disk drive 15, a graphic processing portion 16, a sound processing portion 17, a disk drive 18, a communication interface portion 19, a memory card reader/writer 20, and an input interface portion 21, and further includes a bus 22 for connecting them to one another. The game machine body 11 is connected to the key pad 50 as an operation input portion through the input interface portion 21.

A cross key 51, a button group 52, and the like are disposed at an upper portion of the key pad 50. The button group 52 includes an ◯ button 52a, an x button 52b, a Δ button 52c, and a □ button 52d. A select button 55 is disposed at a coupling portion between a base portion where the cross key 51 is disposed and a base portion where the button group 52 is disposed. A plurality of buttons, such as an R1 button 56 and an L1 button 53, are also disposed at the side portion of the key pad 50.

The key pad 50 includes switches respectively coupled with the cross key 51, the ◯ button 52a, the x button 52b, the Δ button 52c, and the □ button 52d, the select button 55, the R1 button 56, the L1 button 53, and the like, and when a pressing force is applied to each of the buttons, the corresponding switch is turned on. A detection signal corresponding to the on/off setting of the switch is generated in the key pad 50.

The detection signal generated in the key pad 50 is supplied to the input interface portion 21, and the detection signal from the key pad 50 becomes detection information through the input interface 21, which indicates which button on the key pad 50 was turned on. Operation instructions made by the user to the key pad 50 are given to the game machine body 11.

The CPU 12 executes the operating system stored in the ROM 13 and concentrically controls the whole apparatus, and executes a program of a video game stored in a program area of the RAM 14. The CPU 12 monitors the operation state of the key pad 50 through the input interface 21, and if necessary, it executes the program of the video game stored in the program area of the RAM 14, and if necessary, it stores various data produced in the process of game progress into a predetermined area of the RAM 14. The ROM 13 includes an EEPROM (Electrically Erasable and Programmable Read Only Memory), and predetermined data of the RAM 14 which is required to be stored and held even at the time of cutoff of power supply is stored in the EEPROM at the stage before the cutoff of the power supply.

The RAM 14 mainly includes a program area, an image data area, and a voice data area, and further includes an area for storing other data. Program data, image data, voice data, and other data read out of a disk 30, such as a DVD or a CD-ROM, by the disk drive 18 are stored in the respective areas.

The RAM 14 is used also as a work area, and various data produced in the process of the game progress are also stored in the area for storing the other data. Incidentally, the program data, the image data, the voice data, and the other data read out of the disk 30 can also be stored in the hard disk drive 15, and the program data, the image data, the voice data, and the other data once stored in the hard disk drive 15 may be transferred to the RAM 14 as the need arises. Besides, various data produced in the process of the game progress and once stored in the RAM 14 may be transferred to and stored in the hard disk drive 15.

The graphic processing portion 16 includes a frame buffer, in a VRAM 23, as a buffer memory for storing image data, generates a video signal on the basis of the image data stored in the frame buffer by control information from the CPU 12 resulting from execution of the program, and outputs the video signal to the television set 100. By this, a screen display by the image data stored in the frame buffer is carried out on a screen display portion 101 of the television set 100.

The sound processing portion 17 functions to generate voice signals of BGM (background music), a conversation between characters, an effect sound, and the like. The sound processing portion 17 outputs a sound signal including the voice signal to a speaker 102 of the television set 100 by the control information from the CPU 12 resulting from the execution of the program and on the basis of the data stored in the RAM 14.

The television set 100 includes the screen display portion 101 and the speaker 102, and carries out a picture (image) display and a sound output corresponding to the content of the video game on the basis of the video signal (picture signal) and the sound signal from the game machine body 11.

The disk drive 18 is structured such that the disk (DVD or CD-ROM) 30 as a recording medium can be detachably set, and reads out the program data, the image data, the voice data, and the other data of the video game stored in the disk 30.

The communication interface portion 19 is connected to a network 110, and carries out a data communication with a data storage apparatus or an information processing apparatus, such as a server, installed at another place and acquires various data. Incidentally, the program data, the image data, the voice data, and the other data of the video game stored in the RAM 14 may be acquired through the network 110 and the communication interface portion 19.

The memory card reader/writer 20 is structured such that a memory card 31 can be detachably set, and writes save data of relatively low capacity, such as data of the video game still in progress or environment setting data of the video game, into the memory card.

A program of a video game which causes characters, including player characters and enemy characters, to be displayed on a screen and which can control a battle between the characters is recorded in the recording medium of the embodiment of the present invention, that is, the disk 30, and can be read by a computer (the CPU 12 and its peripheral devices). This computer can execute a step of comparing a parameter for regulating action power of a character with a threshold value, and a step of selecting a predetermined speech from previously prepared speeches in accordance with a comparison result obtained at the comparing step.

The computer can also execute a step of judging a progress state of the game and at the selecting step, it can select a predetermined speech from the previously prepared speeches also in accordance with a judgment result obtained at the judging step.

The computer can further execute a step of deciding a character who utters the predetermined speech, and a step of judging whether or not the predetermined speech is made effective on the basis of the character decided at the deciding step and information given to the character and set in accordance with each set zone of a virtual space.

The computer can also execute a step of switching to an image from a predetermined viewpoint among previously prepared images from view points in accordance with a comparison result obtained at the comparing step.

Accordingly, the game machine body 11 has, in addition to functions necessary for carrying out a conventional video game by software processing on the basis of the CPU 12 and data stored in the memories of the respective portions, the function of comparing the parameter for regulating the action power of the character with the predetermined threshold value, and the function of selecting the predetermined speech from the previously prepared speeches in accordance with the comparison result obtained by the comparing function.

The game machine body 11 further has the function of judging the progress state of the game. The game machine body 11 further has the function of deciding the character who utters the predetermined speech, and the function of judging whether or not the predetermined speech is made effective on the basis of the character decided by the deciding function and the information given to the character and set in accordance with the respective set zone of the virtual space. The game machine body 11 also functions to switch the image from the predetermined viewpoint among the previously prepared images from the viewpoints in accordance with the comparison result obtained by the comparing step.

Thus, the speech can be flexibly selected in accordance with the state of the character and the progress state of the game, and the video game which can prevent the loss of interest can be realized. These functions may be realized by providing dedicated hardware instead of realizing these functions by software processing.

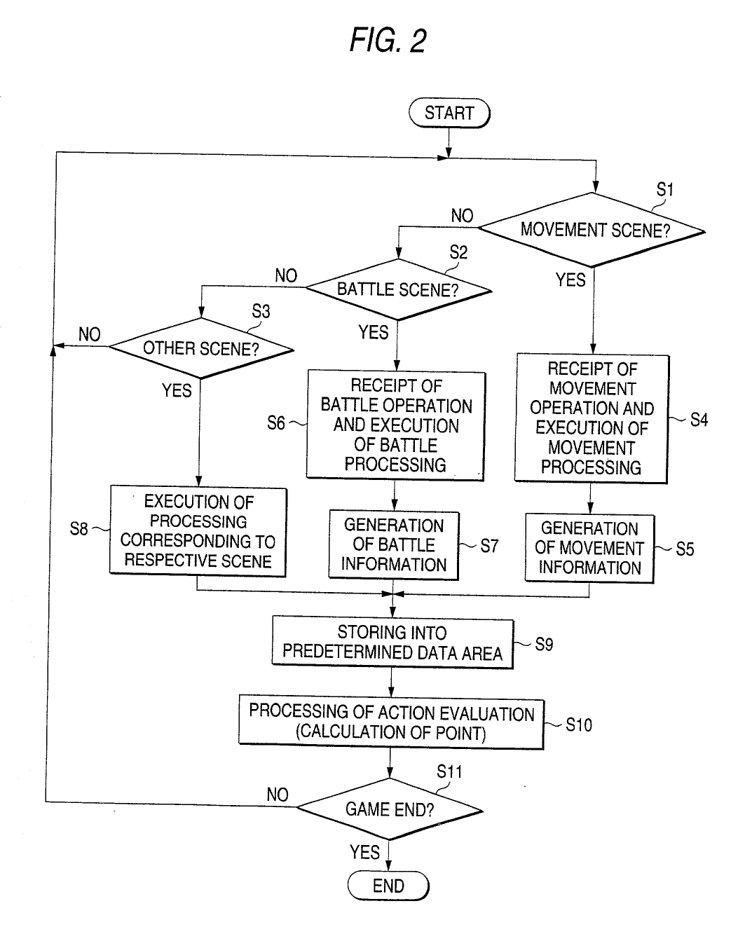

Next, the operation of the embodiment structured as described above will be described. FIG. 2 is a schematic flowchart of an example showing a processing procedure of the whole operation of the foregoing embodiment. Step S1 to step S11 as reference characters are given to respective steps in FIG. 2.

First, although omitted in FIG. 2, when an electric power supply is turned on, a boot program is read out, the respective portions are initialized, and the processing for starting the game is carried out. That is, program data, image data, voice data, and other data stored in the disk (DVD or CD-ROM) 30 are read by the disk drive 18, and the respective data are stored in the RAM 14, and if necessary, data stored in the writable nonvolatile memory, such as the EEPROM of the ROM 13, the hard disk drive 15, or the memory card 31, is read out and is stored in the RAM 14. Then, various settings are made before the actual progress of the game, and a game progress enabling state is first obtained. Accordingly, when the game is made to progress in this state, one of a movement scene, a battle scene, another scene and the like is produced and the procedure proceeds to step S1.

At step S1, it is judged whether or not the scene is a movement scene, and in the case where it is judged that the scene is not the movement scene, the procedure proceeds to step S2, where it is judged whether or not the scene is a battle scene. At step S2, in the case where it is judged that the scene is not the battle scene, the procedure proceeds to step S3, where it is judged whether or not the scene is an other (i.e., conversation, shopping, picking up, etc.) scene. At step S3, in the case where it is judged that the scene is not the other scene, the procedure returns to step S1, and the processings of step S1 to step S3 are repeated and a waiting state occurs.

In this state, in the case where it is judged at step S1 that the scene is the movement scene, the procedure proceeds to step S4, and a receiving state of a movement operation occurs. Then, a movement processing is carried out in accordance with the received movement operation. When the movement processing is completed, the procedure proceeds to step S5, and movement information is generated on the basis of the position information of a player character successively produced from the movement processing. The movement information also includes information indicating the set zone in the virtual space where the present player character is positioned. When the movement information is generated, the procedure proceeds to step S9.

At step S2, in the case where it is judged that the scene is the battle scene, the procedure proceeds to step S6, and a receiving state of a battle operation occurs. Then, a battle processing in accordance with the received battle operation is carried out. When the battle processing is completed, battle information (step S7) is generated. The battle information includes information indicating names of fighting enemy characters, the progress of a battle, and the result of the battle, and digitized information as a parameter for regulating action power of a player character, and in this explanation, the parameter for regulating the action power of the player character is called a hit point. When the battle information is generated, the procedure proceeds to step S9.

At step S3, in the case where it is judged that the scene is the other (i.e., conversation, shopping, picking up, etc.) scene, the procedure proceeds to step S8, so that a processing corresponding to the respective scene is carried out, the other information corresponding to the processing is generated, and the procedure proceeds to step S9.

When the procedure proceeds to step S9, the movement information is stored in a predetermined data area of the RAM 14, so that the present position of the player character is successively renewed. Besides, together with that, the battle information and the other information are stored in the predetermined data area of the RAM 14 for every set zone. That is, an action history of the player character is stored and held for every set zone.

Then, at step S10, an action evaluation processing is carried out on the basis of information indicating the action history of the player character once stored in the RAM 14. Specifically, information required to be digitized is digitized by using a previously prepared conversion table, and information requiring weighting is multiplied by a predetermined coefficient, and those numerical values are added up, and a point is calculated. The calculated point is added to an old point stored in the predetermined data area of the RAM 14, and is again stored in the predetermined data area, so that the point as evaluation information is successively renewed.

When the action evaluation processing is completed in this way, the procedure proceeds to step S11 to determine whether or not the game is ended. When it is judged that the game is not ended, the procedure returns to step S1, and the foregoing processings of step S1 to step S10 are repeated.

In the case where it is judged at step S10 that the game has ended, although omitted in FIG. 2, the information indicating the action history of the character stored in the predetermined data area of the RAM 14, the evaluation information, the set information of the power of the player character, and the like are respectively read out of the RAM 14, and are transferred to and stored in the writable nonvolatile memory, such as the EEPROM of the ROM 13, the hard disk drive 15, or the memory card 31, together with the other data. After other various processings resulting from the end of the game are carried out, the power supply voltage is cut off, and the game is ended. The various information and other data stored in the nonvolatile memory by the save processing of the data before the cutoff of the power supply voltage are read out of the saving nonvolatile memory when the power supply voltage is again applied, and are again stored in the same data area of the RAM 14 in which they were stored before the cutoff of the power supply voltage.

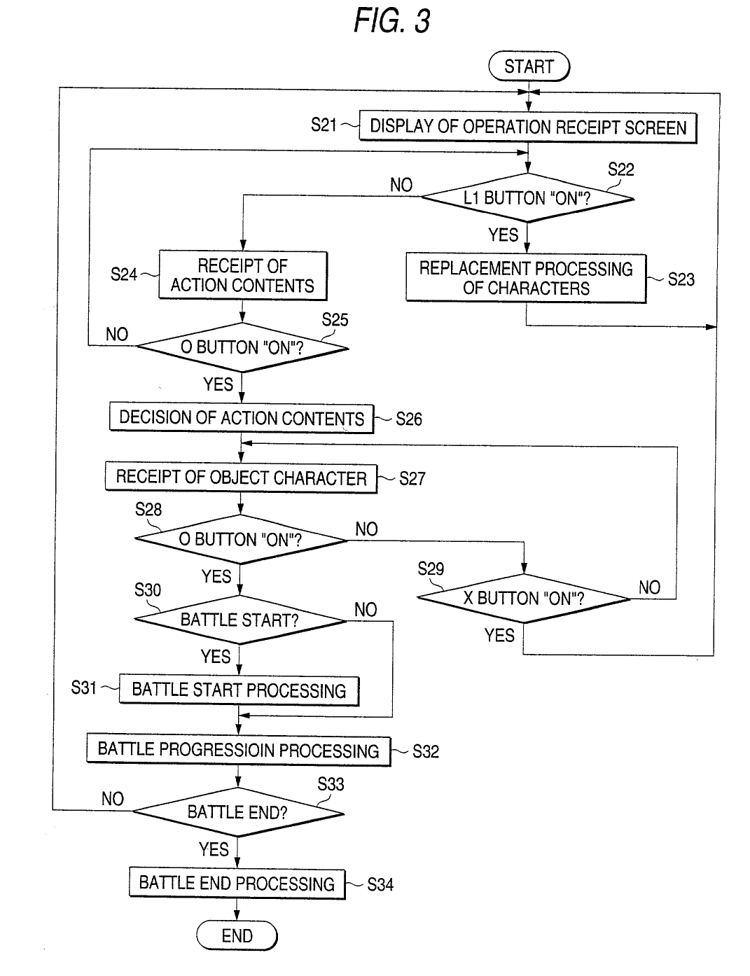

FIG. 3 is a schematic flowchart of an example showing a processing procedure concerning the battle operation reception and the battle processing execution (step S6) of the foregoing embodiment. The battle operation reception and the battle processing execution of the foregoing embodiment will be described with reference to FIG. 3. Step S21 to step S34 are reference characters given to respective steps in FIG. 3. This embodiment is structured such that a battle can be executed in an arbitrary combination of player characters and enemy characters, and further, a player character participating in the battle can be changed by a backup character.

First, when the procedure proceeds to a step of the battle operation reception and the battle processing execution starts, at step S21, a screen for receiving the battle operation is displayed. On this screen, a window for selecting the action content (command input) of a character is displayed, and player characters and enemy characters are displayed to confront with one another.

At step S22, it is judged whether or not the L1 button 53 is pressed. When it is determined that the L1 button 53 is pressed, the procedure proceeds to step S23 where there occurs a state in which a predetermined player character can be changed by a backup character. That is, the backup character is selected in accordance with the operation of the player, and an exchange processing of characters is carried out between the selected backup character and the predetermined player character as the need arises. When the exchange processing of the characters is completed, the procedure returns to step S21, and the screen for receiving the battle operation is displayed.

When it is determined at step S22 that the L1 button 53 is not pressed, the procedure proceeds to step S24, where there occurs a reception state of action content (command input) to be executed by the predetermined player character, and the action content is selected in accordance with the operation of the cross key 51. Then, at step S25, it is judged whether or not the ◯ button 52a is pressed. When it is judged that the 0 button 52a is not pressed, the procedure returns to step S22. When the L1 button 53 is pressed (or the 0 button 52a is pressed), the processing of step S22, step S24 and step S25 are repeated and a waiting state occurs.

In this state, in the case where it is judged at step S25 that the ◯ button 52a is pressed, the procedure proceeds to step S26, the action content is determined to be one selected at that time, and various processings resulting from that are carried out, and further, the display screen is changed to a battle execution screen. Then, the procedure proceeds to step S27, there occurs a reception state of a candidate character which is expected to be an object of action of the player character, and the candidate character is selected in accordance with the number of pressing times of the cross key 51.

Then, at step S28, it is judged whether or not the ◯ button 52a is pressed. In the case where it is judged that the ◯ button 52a is not pressed, the procedure proceeds to step S29, and it is judged whether or not the x button 52b is pressed. In the case where it is judged that the x button 52b is not pressed, the procedure returns to step S27, and until the ◯ button 52a is pressed or the x button 52b is pressed, the processings of step S27 to step S29 are repeated and the waiting state occurs while a selection of the candidate character is received.

In the case where it is judged at step S28 that the ◯ button 52a is pressed, the candidate character is decided as an object of action, and the procedure proceeds to step S30. When the procedure proceeds to step S30, it is judged whether or not the battle starts, and in the case where it is judged that the battle starts, the procedure proceeds to step S31, a battle start processing is executed, and only when predetermined conditions are satisfied, a predetermined speech is uttered from the character. When the battle start processing is completed, the procedure proceeds to step S32. In the case where it is judged at step S30 that the battle does not start, the procedure directly proceeds to step S32.

When the procedure proceeds to step S32, a battle progress processing is executed. For example, in the case where the action content is an attack action, the predetermined player character executes the attack action against the enemy character as the attack object, and the hit point of the enemy character is decreased according to the degree of success of the attack. Besides, in accordance with an internal processing, the enemy character executes the attack action against the predetermined player character as the need arises, and the hit point of the attacked player character is decreased according to the degree of success of the attack.

When one attack between both characters is completed in this way, the procedure proceeds to step S33, and it is judged whether or not the battle is ended. That is, it is judged whether or not the hit points of both the player character and the enemy character are predetermined values or higher, and in the case where it is judged that the hit points of both are the predetermined value or higher, the procedure is returned to step S21, and the foregoing processings of step S21 to step S33 are again repeated.

In the case where it is judged at step S33 that the hit points of both are lower than the predetermined value, victory or defeat has been decided and the procedure proceeds to step S34. That is, one whose hit point becomes the predetermined value or lower becomes a loser, and the other becomes a winner. When the procedure proceeds to the step S34, the battle end processing is executed, and only when predetermined conditions are satisfied, a predetermined speech is uttered from the character. When the battle end processing is executed in this way, the series of steps of the battle operation reception and the battle processing execution are ended.

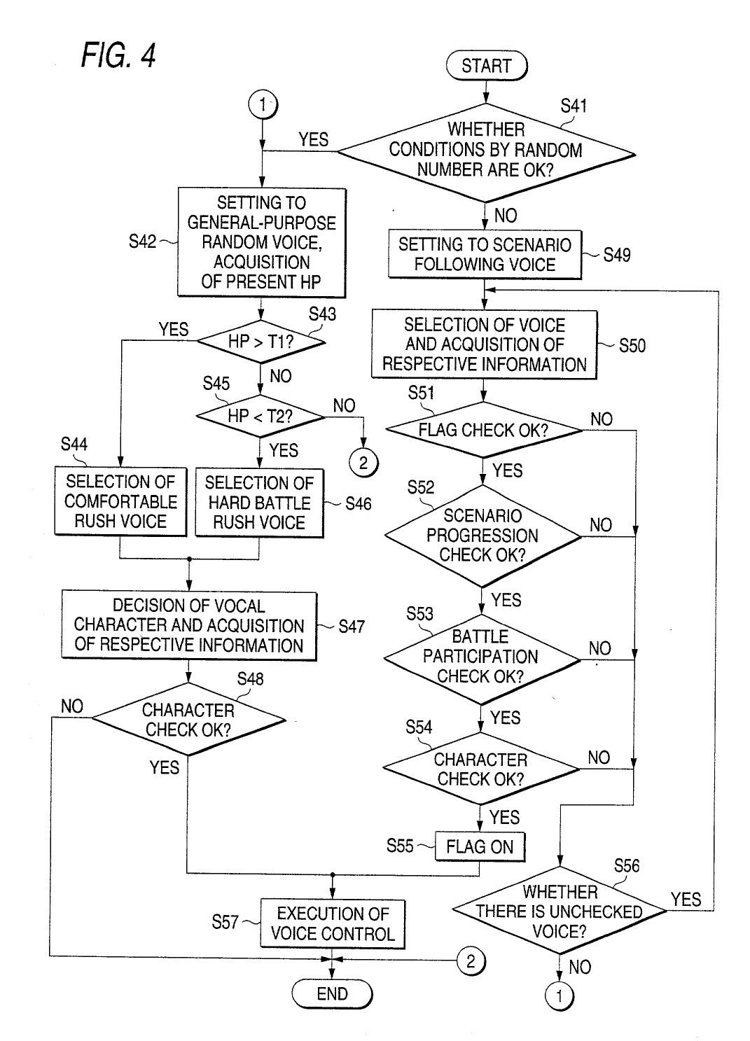

FIG. 4 is a schematic flowchart of an example showing a processing procedure concerning a voice control in the battle start processing (step S31) of the foregoing embodiment. The battle start processing will be described with reference to FIG. 4. Step S41 to step S57 are reference characters given to respective steps in FIG. 4.

In this embodiment, two kinds of speeches in rough classification are prepared. One kind of speech that can be repeatedly selected are called general-purpose random voices in this explanation. The other kind of speeches cannot be again selected when they are once selected. These speeches are called scenario follow-up voices in this explanation. As the general-purpose random voices, two kinds of speeches are prepared as speeches used at the battle start processing, and they are called a comfortable rush voice and a hard battle rush voice.

When the procedure proceeds to the battle start processing, a judgment processing using a random number is carried out at step S41. Specifically, the random number is divided by three, and it is judged whether or not the obtained remainder is two. In the case where it is judged that the remainder is two, the procedure proceeds to step S42, setting for reproducing the general-purpose random voice is carried out, and the present hit point HP of the predetermined player character at that point of time is acquired.

When the hit point HP is acquired, the procedure proceeds to step S43, the hit point HP is compared with a predetermined threshold value T1, and it is judged whether or not (HP>T1) is satisfied. In the case where it is judged that (HP>T1) is satisfied, the procedure proceeds to step S44, the comfortable rush voice is selected, and the procedure proceeds to step S47. At step S43, in the case where it is judged that (HP>T1) is not satisfied, the procedure proceeds to step S45, the hit point HP is compared with a predetermined threshold value T2 (T1>T2), and it is judged whether or not (HP<T2) is satisfied. In the case where it is judged that (HP<T2) is satisfied, the procedure proceeds to step S46, a hard battle rush voice is selected, and the procedure proceeds to the step S47. In the case where it is judged at step S45 that (HP<T2) is not satisfied, any processing is not carried out and the series of battle start processings are ended.

When the procedure proceeds to step S47, a voice character is decided, and control information given to the character for each set zone is acquired. On the basis of the control information, a character check is made at step S48. That is, it is judged whether or not vocalization of the selected voice (speech) is allowed in the set zone at the present position, and in the case where it is judged that the vocalization of the voice is allowed, the procedure proceeds to step S57. At step S57, voice control for reproducing the selected predetermined voice is executed.

Specifically, the predetermined control information generated in the CPU 12 is supplied to the sound processing portion 17, so that the comfortable rush voice or the hard battle rush voice is reproduced. For example, in the case where (HP>T1) is satisfied and the comfortable rush voice is selected, the predetermined character says, for example, “I will settle at one stroke!”. On the other hand, where (HP<T2) is satisfied and the hard battle voice is selected, the predetermined character says, for example, “Do not give up!”. When the predetermined speech is reproduced in this way, the series of battle start processings are ended. In the case where it is judged at step S48 that the vocalization of the speech is not allowed, any processing is not executed and the series of battle start processings are ended.

On the other hand, at step S41, the random number is divided by, for example, three, and in the case where it is judged that the obtained remainder is not two, the procedure proceeds to step S49, and setting for reproducing the scenario follow-up voice is carried out. When the setting for reproducing the scenario follow-up voice is completed, the procedure proceeds to step S50, one voice is selected in predetermined sequence, and various information given to the voice is acquired. For example, a flag indicating a selected/unselected state, information indicating a voice character, control information for the respective set zone are given to each voice included in the scenario follow-up voices, and the information is acquired, and further, information indicating the last action history of the voice character stored and held in the process of the game progress is acquired.

Then, at step S51, the flag check is made, and it is judged whether or not selection has been carried out. In the case where it is judged that the selection has not been carried out, the procedure proceeds to step S52, and the scenario progress check is made. Specifically, it is judged whether or not vocalization is allowed by the information indicating the last action history of the voice character. In the case where it is judged that the vocalization is allowed, the procedure proceeds to step S53, and it is judged whether or not the voice character participates in the battle at present. In the case where it participates in the battle at present, the procedure proceeds to step S54, and the character check is made. That is, it is judged whether or not the vocalization of the selected voice is allowed in the set zone at the present position, and in the case where it is judged that the vocalization of the voice is allowed, the procedure proceeds to step S55. Then, at step S55, the flag indicating the selected/unselected state is set, and at step S57, voice control for reproducing the selected predetermined voice is executed.

Incidentally, at step S51, in the case where it is judged that the state is not the unselected state, the procedure proceeds to step S56. Similarly, at step S52, in the case where it is judged that the vocalization of the voice is not allowed, or in the case where the vocal character does not participate in the battle at present, or at step S54, in the case where vocalization of the voice is not allowed, the procedure proceeds to step S56. At step S56, it is judged whether or not an unchecked voice exists in the scenario follow-up voices, and in the case where it is judged that the unchecked voice exists, the procedure returns to step S50, a next one voice is selected in predetermined sequence, and the processings of step S50 to step S56 are repeated. After the flag is set only to the voice satisfying conditions, the voice control is executed. Incidentally, at step S56, in the case where it is judged that an unchecked voice does not exist in the scenario follow-up voices, the procedure proceeds to step S42, and in the following, the foregoing processings are similarly carried out.

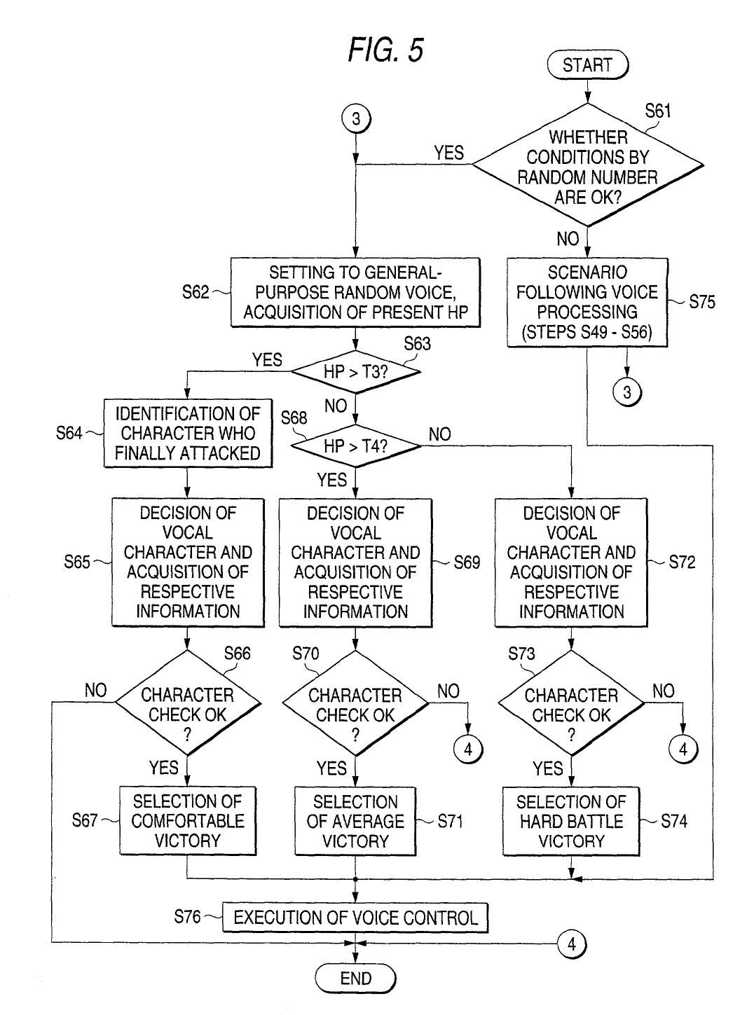

FIG. 5 is a schematic flowchart as an example showing a processing procedure concerning voice control in the battle end processing (step S34) of the foregoing embodiment. The battle end processing will be described with reference to FIG. 5. Incidentally, step S61 to step S76 as reference characters are given to respective steps in FIG. 5. As general-purpose random voices, three kinds of voices are prepared as speeches used for the battle end processing, and they are called a comfortable victory voice, an average victory voice, and a hard battle victory voice.

First, when the procedure proceeds to the battle end processing, at step S61, a judgment processing using a random number is carried out. Specifically, the random number is divided by, for example, three, and it is judged whether or not the obtained remainder is two. In the case where it is judged that the remainder is two, the procedure proceeds to step S62, and setting for reproducing the general-purpose voice is carried out, and further, the present hit point HP of the predetermined player character at the point of time is acquired.

When the hit point HP is acquired, the procedure proceeds to step S63, the hit point HP is compared with a predetermined threshold value T3, and it is judged whether or not (HP>T3) is satisfied. In the case where it is judged that (HP>T3) is satisfied, the procedure proceeds to step S64, identification of the character who finally attacked is carried out, and at step S65, a voice character is determined, and control information given to the character for each set zone is acquired. On the basis of the control information, at step S66, a character check is made. That is, it is judged whether or not vocalization of a selected voice (speech) is allowed in the set zone at the present position, and in the case where the vocalization of the voice is allowed, the procedure proceeds to step S67. Then, at step S67, the comfortable victory voice is selected, and the procedure proceeds to step S76.

At step S63, in the case where it is judged that (HP>T3) is not satisfied, the procedure proceeds to step S68, the hit point HP is compared with a predetermined threshold value T4 (T3>T4), and it is judged whether or not (HP>T4) is satisfied. In the case where it is judged that (HP>T4) is satisfied, the procedure proceeds to step S69, and a vocal character is determined, and further, control information given to the character for each set zone is acquired. On the basis of the control information, a character check is made at step S70. That is, it is judged whether or not vocalization of a selected voice (speech) is allowed in the set zone at the present position, and in the case where it is judged that the vocalization of the voice is allowed, the procedure proceeds to step S71. At step S71, the average victory voice is selected, and the procedure proceeds to step S76.

At step S68, in the case where it is judged that (HP>T4) is not satisfied, the procedure proceeds to step S72, and a vocal character is decided, and further, control information given to the character for each set zone is acquired. On the basis of the control information, a character check is made at step S73. That is, it is judged whether or not vocalization of a selected voice (speech) is allowed in the set zone at the present position, and in the case where it is judged that the vocalization of the voice is allowed, the procedure proceeds to step S74. Then, at step S74, the hard battle victory voice is selected, and the procedure proceeds to step S76.

When the procedure proceeds to step S76, a voice control for reproducing the selected predetermined voice is executed. Specifically, the predetermined control information generated in the CPU 12 is supplied to the sound processing portion 17, so that the comfortable victory voice, the average victory voice or the hard battle victory voice is reproduced. For example, in the case where (HP>T3) is satisfied and the comfortable victory voice is selected, the predetermined character says “I hope to always have this end”. Besides, in the case where (T3≧HP>T4) is satisfied and the average victory voice is selected, the predetermined character says “Well, let's go . . . ”. In the case where (T4≧HP) is satisfied and the hard battle victory voice is selected, the predetermined character says “Oh, . . . ”. When the predetermined speech is reproduced in this way, the series of battle end processings are ended. Incidentally, at the step S66, the step S70 and the step S73, in the case where it is judged that the vocalization of the speech is not allowed, any processing is not carried out and the series of battle end processings are ended.

On the other hand, at the step S61, the random number is divided by three, and in the case where it is judged that the obtained remainder is not two, the procedure proceeds to step S75, and the scenario follow-up voice processings of step S49 to step S56 are carried out. Only in the case where conditions are satisfied, the procedure proceeds to step S76, the voice control for reproducing the predetermined voice is executed, and the series of battle end processings are ended. Incidentally, in the case where it is judged that an unchecked voice does not exist in the scenario follow-up voices, the procedure proceeds to step S62, and in the following, the foregoing processings are similarly carried out.

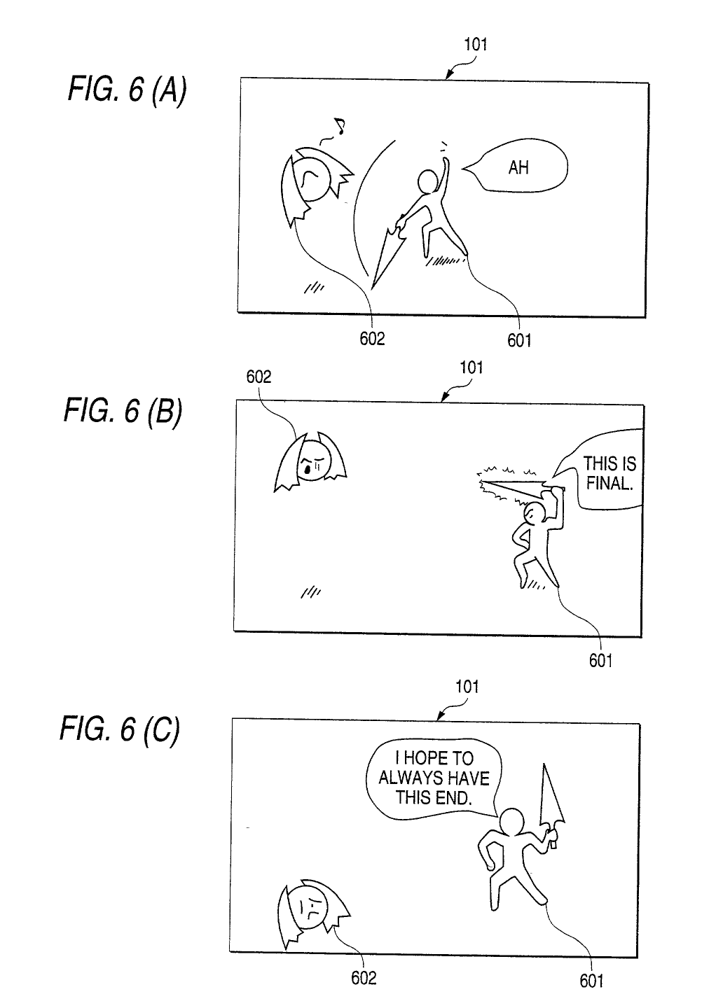

FIGS. 6A to 6C show examples of specific display screens concerning the battle progress processing (step S32) and the battle end processing (step S34) of the foregoing embodiment. The battle progress processing (step S32) and the battle end processing (step S34) of the foregoing embodiment will be further described with reference to FIGS. 6A to 6C. Incidentally, in FIGS. 6A, 6B and 6C, reference numeral 601 designates a player character participating in the battle; and 602, an enemy character. In the drawings, a speech is expressed by a balloon for convenience. Besides, this embodiment is structured such that it is also possible to switch to an image from a predetermined viewpoint among previously prepared images from viewpoints.

In the battle progress processing, the battle progresses as shown in FIG. 6A, and in the case where the received action content is the attack action, the player character 601 executes the attack action against the enemy character 602, and the hit point of the enemy character is decreased in accordance with the degree of success of the attack. Incidentally, FIG. 6A shows a state in which the attack is failed, and the player character 601 says a speech of “Ah”. Besides, in accordance with an internal processing, the enemy character executes the attack action against the player character as the need arises, and in accordance with the degree of success of the attack, the hit point of the player character 601 is decreased.

The battle progresses in this way, and it is assumed that the player character 601 is predominant, and each time one attack between both the characters is completed, the hit point of the enemy character 602 continues to decrease, and the player character 601 wins. In this case, immediately before the end of the battle, the hit point of the enemy character is compared with a threshold value near the lower limit value, so that it is presumed that the battle is ended at the next attack, and the predetermined control information generated in the CPU 12 is supplied to the graphic processing portion 16 and is supplied to the sound processing portion 17. Thus, as shown in FIG. 6B, the player character 601 says a speech of “This is final”, and at the next instant, the switchover to an image within point-blank range, in which the state of the enemy character 602 as a defeated side can be easily confirmed, is made and the attack is executed.

When the hit point of the enemy character 602 becomes the lower limit value or lower and the battle is ended, the procedure proceeds to the foregoing battle end processing. Here, the hit point HP of the player character is (HP>T3), and in the case where the comfortable victory voice is selected, as shown in FIG. 6C, the player character 601 says a speech of “I hope to always have this end”, and at the next instant, the switchover to an image within point-blank range, in which the state of the player character 601 as a winner side can be easily confirmed, is made. Thus, the control is made so that the progress of the screen coincides with the progress of the speech, and the realism is further raised.

Accordingly, the foregoing embodiment has the following effects. The first effect is that since the predetermined speech is selected and reproduced in accordance with the state of the character, it becomes possible to prevent the loss of interest. Next, the second effect is that since the previously prepared speeches include the speeches which can be repeatedly selected and the speeches which can not be again selected once they are selected, the speeches are diversified, and it becomes possible to further prevent the loss of interest. Further, the third effect is that since the predetermined speech is selected and reproduced also in accordance with the progress state of the game, it becomes possible to further prevent the loss of interest. Moreover, the fourth effect is that it is judged whether or not the predetermined speech is made effective on the basis of the information given to the character and set in accordance with each set zone of the virtual space, the relation between the speaking character and the speech can be made complicated, and it becomes possible to further prevent the loss of interest. The fifth effect is that since the predetermined speech is uttered, and the switchover to the image from the predetermined viewpoint can be made in accordance with that, the realism is further raised, and it becomes possible to prevent the loss of interest.

Next, another embodiment will be described. In the foregoing embodiment, the description has been given of the case where when the speech is selected, the judgment is made by using the hit point of the predetermined character player. However, the respective hit points of the player characters are acquired, and the predetermined speech may be selected through the total hit point, for example, by summing up the acquired hit points or calculating the average.

In the foregoing embodiment, the description has been given of the case where the parameter for regulating the action power of the predetermined character, that is, the hit point is used to select the predetermined speech. However, in the case where the action power of the character is regulated by parameters, if necessary, by giving weight and summing up them or by calculating the average, they may be regarded as one parameter to be used.

Further, in the foregoing embodiment, the description has been given of the case where one speech is merely selected and reproduced with respect to one vocal character. However, information to specify a next speech is given to each speech, and the speeches may be continuously uttered among different characters. Besides, a dialog of a series of speeches over the respective characters may be regarded as one speech to be processed. By this, the speeches are diversified, and it becomes possible to further prevent the loss of interest.

In the foregoing embodiment, the description has been given of the case where only the content of the speech is selected. However, speeches having the same content and different tones are prepared in the previously prepared speeches, and the speech of the predetermined content and the predetermined tone may be selected in accordance with the comparison result between the hit point and the predetermined threshold value. Not only the content of the speech is selected in accordance with the state of the character, but also the tone of the speech is made a predetermined one, so that it becomes possible to further prevent the loss of interest.

In the foregoing embodiment, the description has been given of the case where the predetermined speech is selected in accordance with the comparison result between the hit point and the predetermined threshold value at the processing of the general-purpose random voice side. However, also at the scenario follow-up voice side, judgment may be made as to whether or not the predetermined speech is made effective in accordance with the comparison result between the hit point and the predetermined threshold value.

Incidentally, it is apparent that the present invention is not limited to the above respective embodiments, but the respective embodiments can be suitably modified within the scope of technical concept of the present invention. For example, the order of the steps in the method of the present invention can be changed within the scope not departing from the gist of the present invention or its scope. Incidentally, the same reference characters are given to the same structural elements in the respective drawings.

As described above, according to the present invention, the speech can be flexibly selected in accordance with the state of the character and the progress state of the game, and it becomes possible to prevent the loss of interest.

What is claimed is:

1. A computer readable recording medium recording a program of a video game in which a plurality of characters including player characters and enemy characters are displayed on a screen and a battle between the characters can be controlled, the program causing a computer to:
compare a parameter for regulating an action power of a character with a predetermined threshold value; and
select a predetermined speech from a plurality of previously prepared speeches in accordance with a comparison result obtained at the comparing step.

2. A computer readable recording medium according to claim 1, wherein the plurality of previously prepared speeches include speeches which can be repeatedly selected and speeches which can not be again selected when they are once selected.

3. A computer readable recording medium according to claim 1, wherein the plurality of previously prepared speeches correspond to the respective characters, and selecting a predetermined speech comprises successively selecting a plurality of predetermined speeches.

4. A computer readable recording medium according to claim 1, wherein the plurality of previously prepared speeches include speeches which have the same content and different tones, and selecting a predetermined speech comprises selecting a speech of a predetermined content and a predetermined tone in accordance with an obtained comparison result.

5. A computer readable recording medium according to claim 1, wherein the recording medium records the program which further causes the computer to determine a progress state of the game, and
a predetermined speech is selected among the plurality of previously prepared speeches in accordance with the determined progress state of the game.

6. A computer readable recording medium according to claim 1, wherein the recording medium records the program which further causes the computer to:
decide what character utters the predetermined speech; and
judge whether or not the predetermined speech is made effective on the basis of the decided character and information given to the character and set in accordance with each set zone of a virtual space.

7. A computer readable recording medium according to claim 1, wherein the recording medium records the program which further causes the computer to switch to an image from a predetermined viewpoint among previously prepared images from a plurality of viewpoints in accordance with an obtained result.

8. A program of a video game in which a plurality of characters including player characters and enemy characters are displayed on a screen and a battle between the characters can be controlled, the program causing a computer to:
compare a parameter for regulating an action power of a character with a predetermined threshold value; and
select a predetermined speech from a plurality of previously prepared speeches in accordance with an obtained comparison result.

9. A program of a video game according to claim 8, wherein the plurality of previously prepared speeches include speeches which can be repeatedly selected and speeches which can not be again selected when they are once selected.

10. A program of a video game according to claim 8, wherein the plurality of previously prepared speeches correspond to respective characters, the plurality of predetermined speeches being successively selected.

11. A program of a video game according to claim 8, wherein the plurality of previously prepared speeches include speeches which have the same content and different tones, a speech of a predetermined content and a predetermined tone being selected in accordance with an obtained comparison result.

12. A program of a video game according to claim 8, wherein the program further causes the computer to judge a progress state of the game, a predetermined speech being selected from among the plurality of previously prepared speeches in accordance with an obtained judgment result.

13. A program of a video game according to claim 8, wherein the program causes the computer to:
decide what character utters the predetermined speech; and
judge whether or not the predetermined speech is made effective on the basis of the decided character and information given to the character and set in accordance with each set zone of a virtual space.

14. A program of a video game according to claim 8, wherein the program causes the computer to switch to an image from a predetermined viewpoint among previously prepared images from a plurality of viewpoints in accordance with an obtained comparison result.

15. A video game processing method in which a plurality of characters including player characters and enemy characters are displayed on a screen and a battle between the characters can be controlled, comprising:
comparing a parameter for regulating an action power of a character with a predetermined threshold value; and
selecting a predetermined speech from a plurality of previously prepared speeches in accordance with an obtained comparison result.

16. A video game processing method according to claim 15, wherein the plurality of previously prepared speeches include speeches which can be repeatedly selected and speeches which can not be again selected when they are once selected.

17. A video game processing method according to claim 15, wherein the plurality of previously prepared speeches correspond to the respective characters, the plurality of predetermined speeches being successively selected.

18. A video game processing method according to claim 15, wherein the plurality of previously prepared speeches include speeches which have the same content and different tones, a speech of a predetermined content and a predetermined tone being selected in accordance with an obtained comparison result.

19. A video game processing method according to claim 15, further comprising judging a progress state of the game, wherein a predetermined speech is selected from among the plurality of previously prepared speeches in accordance with an obtained judgment result.

20. A video game processing method according to claim 15, further comprising:
deciding what character utters the predetermined speech; and
judging whether or not the predetermined speech is made effective on the basis of the decided character and information given to the character and set in accordance with each set zone of a virtual space.

21. A video game processing method according to claim 15, further comprising switching to an image from a predetermined viewpoint among previously prepared images from a plurality of viewpoints in accordance with an obtained comparison result.

22. A video game processing apparatus, comprising:
a storage device that stores a program of a video game which causes a plurality of characters, including player characters and enemy characters, to be displayed on a screen and can control a battle between the characters;
a computer that executes the program read out of the storage device; and
a display apparatus for screen display, which is provided as an output of the computer,
wherein the computer executes the program so that it compares a parameter for regulating an action power of a character with a predetermined threshold value, and selects a predetermined speech from a plurality of previously prepared speeches in accordance with a comparison result obtained by the comparison.
